(19) United States
(12) Patent Application Publication
(10) Pub. No.: US 2007/0273346 A1
(43) Pub. Date: Nov. 29, 2007

(54) Voltage regulator circuit with over-current protection

(75) Inventors: Chun-San Lin, Taipei City (TW); Jui-Shun Pan, Taipei-City (TW); Hsiang-Jui Hung, Taipei City (TW); Sun-Chen Yang, Taipei City (TW); Ching-Fu Cheng, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/507,446

(22) Filed: Aug. 22, 2006

(30) Foreign Application Priority Data
May 24, 2006 (TW) 095118385

(51) Int. Cl. G05F 1/571

(52) U.S. Cl. 323/276

(57) ABSTRACT

A voltage regulator circuit with over-current protection, which includes a linear regulator, a voltage controller, and an over-current protection circuit. The linear regulator includes a converter and a driver. The converter is connected to a voltage input terminal and a voltage output terminal. An output terminal of the driver is connected to the converter for controlling the operation of the converter. The voltage controller is connected to the voltage output terminal, the output terminal and a first input terminal of the driver, respectively, for providing a feedback voltage. The over-current protection circuit is connected to the output terminal of the driver and the linear regulator. The over-current protection circuit detects the output voltage of the driver for comparing with a comparison voltage. When the output voltage is larger than the comparison voltage, the over-current protection circuit controls the driver to turn off the converter.

### BACKGROUND OF THE INVENTION

1. Field of the Invention

The present invention relates to the technical field of voltage regulator circuit and, more particularly, to a voltage regulator circuit with over current protection.

2. Description of Related Art

Traditional linear regulators generally include an operational amplifier and an active switch that collectively form a step-down converter for stepping down an input voltage and produce a corresponding output voltage. Generally speaking, linear regulator is based on the active switch operating in the linear region (active region) thereof to act like a variable resistor. Besides, the operational amplifier and a compensation circuit within linear regulators are used as a feedback circuit to keep the output voltage relatively constant.

However, the aforementioned configuration of the traditional linear regulators is inefficient: the active switch dissipates a lot of heat operating in the linear region. If the output load or the current flowing through the active switch exceeds a threshold value, then the active switch is likely to become over-heat or burnt out, the latter of which may even cause a short-circuit leading to the direct electrical connection of the load to the input voltage terminal. The short circuit causes the voltage at the load to exceed the maximum input voltage allowed on the load, causing burnout or damage to the load.

To address the above-mentioned problem, a traditional approach is to employ an over-current protection (OCP) circuit to prevent the active switch from damage. FIG. 1 shows a circuit diagram illustrating a traditional linear regulator with over-current protection. The linear regulator includes an operational amplifier 110, a Zener diode 120, an over-current protection circuit 130, a MOS transistor 140, and resistors R1, R2 and R3. The over-current protection circuit 130 is used for detecting a voltage Vη at resistor R3. Since the current I_{D} of the MOS transistor 140 passes through R3, voltage Vη increases with the increasing magnitude of current I_{D}. When voltage Vη exceeds a predetermined voltage, the over-current protection circuit 130 generates a signal to turn off the MOS transistor 140 so as to prevent the MOS transistor 140 from damaging.

As shown in FIG. 1, to detect whether an over-current occurs to the MOS transistor 140, an additional resistor R3 needs to be serially connected thereto. However, when the current I_{D} flows through the resistor R3, the resistor R3 is occurred with power consumption, thus further complicating the issue. That is, the use of the MOS transistor 140 as a variable resistance already brings down the efficiency of the linear regulator due to power dissipation, and the addition of a resistor R3 to provide over-current protection works against the linear regulator to bring down its efficiency even further.

Further, the linear regulator and the over-current protection circuit are packaged in a single IC (Integrated Circuit). Thus, the given IC is constrained to only able to operate under a specific load current. Namely, if a larger load current is required, then the IC needs to be replaced altogether, giving rise to great inconvenience. To solve this problem, a traditional approach is to design the linear regulator and the over-current protection circuit directly on the PCB. However, such approach contributes to a waste of PCB space, and implementing the over-current protection circuit on the PCB remains a complicated process.

Thus, there is a need to improve the afore-mentioned problems associated with the traditional linear regulator circuit with over-current protection.

### SUMMARY OF THE INVENTION

The object of the present invention is to provide a voltage regulator circuit with over-current protection, for solving the afore-mentioned problems associated with prior art.

In accordance with one aspect of the present invention, there is provided a voltage regulator circuit with over-current protection, which includes a linear regulator, a voltage controller, and an over-current protection circuit. The linear regulator includes a converter and a driver. The converter is electrically connected to a voltage input terminal and a voltage output terminal. An output terminal of the driver is electrically connected to the converter, and controls the operation of the controller. The voltage controller is electrically connected to the voltage output terminal, the output terminal of the driver, and the first input terminal of the driver respectively, for providing a feedback voltage. The over-current protection circuit is electrically connected to the driver, and detects an output voltage of the driver for comparing with a comparison voltage. The over-current protection circuit controls the driver to turn off the converter when the output voltage is larger than the comparison voltage.

In accordance with another aspect of the present invention, there is provided a voltage regulator circuit with over-current protection, which includes a converter, a driver, a voltage controller, and an over-current protection circuit. The converter is electrically connected to a voltage input terminal and a voltage output terminal, respectively. An output terminal of the driver is electrically connected to the converter, and controls the operation of the controller. The voltage controller is electrically connected to the voltage output terminal, the output terminal of the driver, and the first input terminal of the driver respectively, for providing a feedback voltage. The over-current protection circuit is electrically connected to the driver, and detects an output voltage of the driver for comparing with a comparison voltage. The over-current protection circuit controls the driver to turn off the converter when the output voltage is larger than the comparison voltage.

By applying the voltage regulator circuit with over-current protection provided by the invention, the converter within the voltage regulator circuit can be prevented from burnout due to over-current, power loss can be reduced, and unnecessary heat dissipation can be avoided.

In an embodiment of the invention, the driver can include a first operational amplifier. The first operational amplifier has a first input terminal and a second input terminal. The first input terminal of the first operational amplifier receives a reference voltage (Vref), and the second input terminal of first operational amplifier is electrically connected to the voltage controller.

In an embodiment of the invention, the voltage regulator circuit with over-current protection includes a current source and a second operational amplifier, which has a first input terminal and a second input terminal. The first input terminal of the second operational amplifier is electrically connected to the output terminal of the first operational amplifier. The second input terminal of the second operational amplifier is electrically connected to the current source.

The second input terminal of the second operational amplifier is also electrically connected to a reference resistor, and the current provided by the current source flows through the reference resistor to generate a comparison voltage.

The driver further includes a first transistor, such as a P-Channel MOSFET. The first operational amplifier further includes a first power supply terminal. The second operational amplifier further includes an output terminal. The output terminal of the second operational amplifier is electrically connected to the first power supply terminal of the first operational amplifier through the first transistor, such that when the output voltage of the first operational amplifier is larger than the comparison voltage, the second operational amplifier turns off the first transistor, to consequently cause the first operational amplifier to cease operation so as to turn off the converter.

In an embodiment of the invention, converter is an active switch. In an embodiment of the invention, the active switch can be a FET (Field Effect Transistor). In other embodiments of the invention, active switch can also be a BJT (Bipolar Junction Transistor). In an embodiment of the invention, the voltage controller is a passive network.

In an embodiment of the invention, the first operational amplifier can include a third input terminal. The second operational amplifier further has an output terminal. The output terminal of the second operational amplifier is electrically connected to the third input terminal of the first operational amplifier, such that when the output voltage of the first operational amplifier is larger than the comparison voltage, the second operational amplifier controls the first operational amplifier to output low voltage biases so as to turn off the converter.

Other objects, advantages, and novel features of the invention will become more apparent from the following detailed description when taken in conjunction with the accompanying drawings.

### BRIEF DESCRIPTION OF THE DRAWINGS

FIG. 1 is a circuit diagram illustrating a conventional voltage regulator circuit with over-current protection;

FIG. 2 is a block diagram illustrating a voltage regulator circuit with over-current protection in accordance with a preferred embodiment of the invention;

FIG. 3 is a circuit diagram illustrating a voltage regulator circuit with over-current protection in accordance with a preferred embodiment of the invention; and

FIG. 4 is a circuit diagram illustrating a voltage regulator circuit with over-current protection in accordance with another embodiment of the invention.

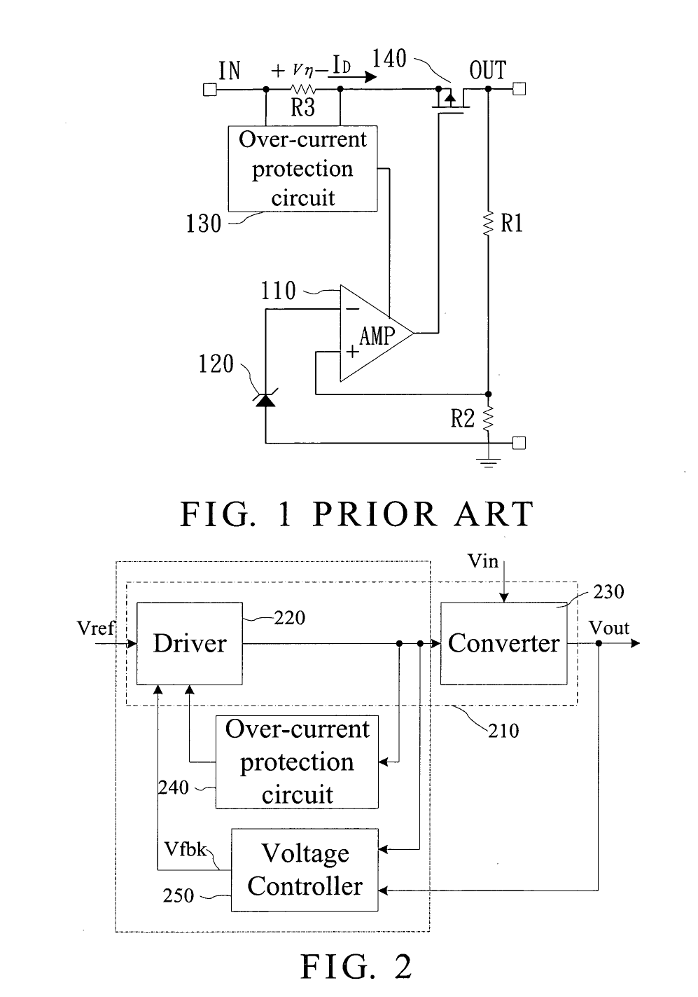

### DETAILED DESCRIPTION OF THE PREFERRED EMBODIMENT

FIG. 2 is a block diagram illustrating a voltage regulator circuit with over current protection in accordance with an embodiment of the invention. As shown in FIG. 2, the voltage regulator circuit includes a linear regulator 210, an over-current protection circuit 240, and a voltage controller 250. The linear regulator 210 includes a converter 230 and a driver 220. The converter 230 is electrically connected to a voltage input terminal Vin and a voltage output terminal Vout. The output terminal of the driver 220 is electrically connected to the converter 230, and the driver 220 can control the operation of the converter 230.

The voltage controller 250 is electrically connected to the voltage output terminal Vout, the output terminal of driver 220, and an input terminal of driver 220, for providing a feedback voltage Vfbk. The over-current protection circuit 240 is electrically connected to the output terminal of driver 220 and the linear regulator 210. The over-current protection circuit 240 detects the output voltage of the driver 220 for comparing with a comparison voltage, and if the output voltage of the driver 220 is larger than the comparison voltage, the over-current protection circuit 240 controls the driver 220 to turn off the converter 230.

In an embodiment of the invention, the driver 220, the over-current protection circuit 240, and the voltage controller 250 ate integrated in a single IC. Thus, in case the load current of the voltage regulator circuit has changed, the voltage regulator circuit can be compensated by simply replacing the converter 230 with one having corresponding load current capacity, giving great flexibility of circuit design. That is, during the design of voltage regulator circuit with over-current protection, a simple replacement of the converter 230 is sufficient to adapt for different current loads, as compared to the traditional approach in which both the linear regulator and the over-current protection circuit needs to be replaced and thus gives rise to costs.

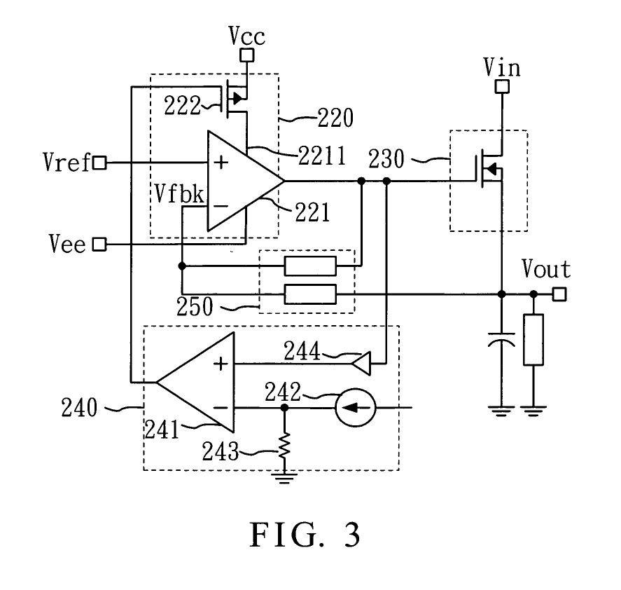

FIG. 3 is a circuit diagram illustrating a voltage regulator circuit with over-current protection in accordance with a preferred embodiment of the invention. As shown in FIG. 3, the driver 220 includes a first operational amplifier 221, and a first transistor 222. In this embodiment, the first transistor 222 is a P-Channel MOSFET transistor. In other embodiments, the first transistor 222 can also be other type of transistors, such as a N-Channel MOSFET, or active switches with different circuit connection to the first transistor 222 which are known to a person skilled in the art and hence the descriptions of which are hereby omitted.

The first operational amplifier 221 has a first input terminal (+) and a second input terminal (−). The first input terminal (+) of the first operational amplifier 221 is used for receiving a reference voltage (Vref). The second input terminal (−) of the first operational amplifier 221 is electrically connected to the voltage controller 250.

In this embodiment, the voltage controller 250 is a passive network, having a first input connected to the output terminal of the first operational amplifier 221, and a second input terminal connected to the output terminal of the converter 230. Thus the voltage controller 250 can generate a feedback voltage Vfbk based on the voltage at the output terminal of the first operational amplifier 221 and the voltage at the output terminal of the converter 220.

The over-current protection circuit 240 includes a second operational amplifier 241 having a first input terminal (+) and a second input terminal (−), a current source 242, a reference resistor 243, and a buffer 244. The first input terminal (+) of the second operational amplifier 241 is electrically connected to the output terminal of first operational amplifier 221 via the buffer 244. The second input terminal (−) of the second operational amplifier 241 is electrically connected to the current source 242. In other embodiments, the first input terminal (+) of the second operational amplifier 241 can also be electrically connected to the output terminal of the first operational amplifier 221 directly.

The second input terminal (−) of the second operational amplifier 241 is electrically connected to one terminal of the reference resistor 243. The other terminal of the reference resistor 243 is connected to a low voltage, and is preferably of zero volts. Through such, the current provided by the current source 242 can flow through the reference resistor 243 and provide a comparison voltage at the second input terminal (−) of the second operational amplifier 241.

The first operational amplifier 221 further has a first power supply terminal 2211. The second operational amplifier 241 further has an output terminal electrically connected to the first power supply terminal 2211 of the first operational amplifier 221 via the first transistor 222.

When the output voltage of the first operational amplifier 221 is larger than the comparison voltage, the second operational amplifier 241 generates a high voltage and outputs the high voltage to the first transistor 222 through the output terminal of the second operational amplifier 241. Since the first transistor 222 is a P-Channel MOSFET transistor, the high voltage generated by the second operational amplifier 241 causes the first transistor 222 to be turned off. The turn-off of the first transistor 222 stops voltage Vcc from being supplied to the first operational amplifier 221. The first operational amplifier 221 thus ceases to operate, thereby also turning off the converter 230.

In this embodiment, the converter 230 is an active switch, such as a field-effect transistor. For instance, the converter 230 in this embodiment is preferably a N-Channel MOSFET. In other embodiments, the converter 230 may be a BJT (bi-polar junction transistor), or other types of transistors with different electrical connections, which are known to a person skilled in the art, and hence the descriptions of which are hereby omitted.

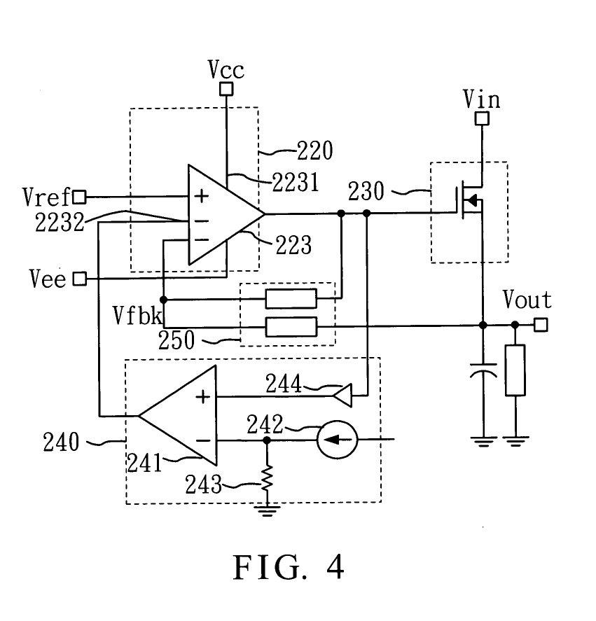

FIG. 4 is a circuit diagram illustrating another preferred embodiment of the invention. As shown in FIG. 4, the driver 220 includes a first operational amplifier 223, which further has a third input terminal (−) 2232. The second operational amplifier 241 has an output terminal, and the output terminal of the second operational amplifier 241 is electrically connected to the third input terminal (−) 2232 of the first operational amplifier 223, such that when the output voltage provided by the first operational amplifier 223 is larger than the comparison voltage, the second operational amplifier 241 controls the first operational amplifier 23 to output a low voltage, such as negative 12V or 0V, for turning off the converter 230.

In view of the foregoing, the voltage regulator circuit with over-current protection in accordance with a preferred embodiment of the invention is able to provide over-current protection by detecting the output voltage of the driver, and comparing the detected output voltage with the reference voltage, thereby successfully eliminating the power loss problem associated with prior art when sense resistor R3 is used, and increasing the efficiency of the linear regulator.

Although the present invention has been explained in relation to its preferred embodiment, it is to be understood that many other possible modifications and variations can be made without departing from the spirit and scope of the invention as hereinafter claimed.

What is claimed is:

1. A voltage regulator circuit with over-current protection, comprising:
a linear regulator, including a converter and a driver, the converter electrically connected to a voltage input terminal and a voltage output terminal, the driver having an output terminal electrically connected to the converter for controlling the operation of the converter;
a voltage controller, electrically connected to the voltage output terminal, the output terminal of the driver, and a first input terminal of the driver respectively, for providing a feedback voltage; and
an over-current protection circuit, electrically connected to the driver, the over-current protection circuit detecting an output voltage of the driver for comparing with a comparison voltage, and controlling the driver to turn off the converter when the output voltage is larger than the comparison voltage.

2. The voltage regulator circuit as claimed in claim 1, wherein the driver includes a first operational amplifier, the first operational amplifier having a first input terminal for receiving a reference voltage, and a second input terminal electrically connected to the voltage controller.

3. The voltage regulator circuit as claimed in claim 2, wherein the over-current protection circuit includes a current source and a second operational amplifier having a first input terminal and a second input terminal, the first input terminal of the second operational amplifier electrically connected to an output terminal of the first operational amplifier, the second input terminal of the second operational amplifier electrically connected to the current source.

4. The voltage regulator circuit as claimed in claim 3, wherein the second input terminal of the second operational amplifier is electrically connected to a reference resistor such that the current provided by the current source flows through the reference resistor to generate a comparison voltage.

5. The voltage regulator circuit as claimed in claim 4, wherein the driver further includes a first transistor, and the first operational amplifier further has a first power supply terminal, and the second operational amplifier further has an output terminal electrically connected to the first power supply terminal of the first operational amplifier through the first transistor, the second operational amplifier turning off the first transistor to terminate the operation of the first operational amplifier so as to turn off the converter when the output voltage of the first operational amplifier is larger than the comparison voltage.

6. The voltage regulator circuit as claimed in claim 1, wherein the converter is an active switch.

7. The voltage regulator circuit as claimed in claim 6, wherein the active switch is a field effect transistor or a bi-polar junction transistor.

8. The voltage regulator circuit as claimed in claim 1, wherein the voltage controller is a passive network.

9. The voltage regulator circuit as claimed in claim 4, wherein the first operational amplifier further has a third input terminal, the second operational amplifier further has an output terminal electrically connected to the third input terminal of the first operational amplifier, the second operational amplifier controlling the first operational amplifier to output a low voltage for turning off the converter when the output voltage of the first operational amplifier is larger than the comparison voltage.

10. A voltage regulator circuit with over-current protection, comprising:
a converter, electrically connected to a voltage input terminal and a voltage output terminal;
a driver, having an output terminal electrically connected to the converter for controlling the operation of the converter;
a voltage controller, electrically connected to the voltage output terminal, the output terminal of the driver, and a first input terminal of the driver respectively, for providing a feedback voltage; and
an over-current protection circuit, electrically connected to the driver, detecting an output voltage of the driver for comparing with a comparison voltage, and controlling the driver to turn off the converter when the output voltage is larger than the comparison voltage.

11. The voltage regulator circuit as claimed in claim 10, wherein the driver includes a first operational amplifier, the first operational amplifier having a first input terminal for receiving a reference voltage and a second input terminal electrically connected to the voltage controller.

12. The voltage regulator circuit as claimed in claim 11, wherein the over-current protection circuit includes a current source and a second operational amplifier having a first input terminal and a second input terminal, the first input terminal of the second operational amplifier electrically connected to an output terminal of the first operational amplifier, the second input terminal of the second operational amplifier electrically connected to the current source.

13. The voltage regulator circuit as claimed in claim 12, wherein the second input terminal of the second operational amplifier is electrically connected to a reference resistor such that the current provided by the current source flows through the reference resistor to generate a comparison voltage.

14. The voltage regulator circuit as claimed in claim 13, wherein the driver further includes a first transistor, and the first operational amplifier further has a first power supply terminal, and the second operational amplifier further has an output terminal electrically connected to the first power supply terminal of the first operational amplifier through the first transistor, the second operational amplifier turning off the first transistor to terminate the operation of the first operational amplifier so as to turn off the converter when the output voltage of the first operational amplifier is larger than the comparison voltage.

15. The voltage regulator circuit as claimed in claim 10, wherein the driver, the voltage controller, and the over-current protection circuit are integrated in an integrated circuit.
